(19) United States
(12) Patent Application Publication
(10) Pub. No.: US 2014/0059126 A1
(43) Pub. Date: Feb. 27, 2014

(54) CONTEXT AWARE SOCIAL CALLBACK

(71) Applicants: Reinhard P. Klemm, Basking Ridge, NJ (US); Doree Duncan Seligmann, New York, NY (US)

(72) Inventors: Reinhard P. Klemm, Basking Ridge, NJ (US); Doree Duncan Seligmann, New York, NY (US)

(73) Assignee: AVAYA INC., Basking Ridge, NJ (US)

(21) Appl. No.: 13/591,049

(22) Filed: Aug. 21, 2012

(51) Int. Cl. G06F 15/16

(52) U.S. Cl. 709/204

(57) ABSTRACT

A server executing a context aware social callback application and method are provided. Posts with action tags made on social media sites or pages that identify a monitoring entity or associated offering are identified. Such posts are analyzed to determine whether they are associated with an identifiable user, and whether they invite interaction. If the identified content is from an identifiable person and if it invites interaction, the application automatically generates a response that is sent to the identified user with a request to engage in further communications. The system can also send the post and/or related information to an agent or other contact center resource for handling.

### FIELD

The present disclosure is directed generally to social media tagging and pop-up notifications and specifically to using these for issue resolution.

### BACKGROUND

Social media channels are gaining momentum as a platform for delivering and receiving customer support. People exchange information or provide commentary about business services or products on social media or social media pages like Twitter®, Facebook®, Flickr®, LinkedIn®, Pinterest®, YouTube®, blogs, RSS, search sites (Google®, Bing®, etc.), etc. Consumers are finding it useful to ask their questions, complain about service, and compliment companies in the public forum. This trend puts an increased burden on companies to deliver service in an open and noisy platform. Companies must find social media data on customers who are having problems and resolve them quickly. The penalty of not engaging in social media is high. Brand protection is critical and prompt customer service is required.

One of the challenges with delivering customer service over social media is first identifying that there is an issue. Getting back to a customer in the fastest way possible using the customer's preferred method of communication is another challenge. The best customer service can only be delivered if a company is aware of a post that identifies an issue and can contact the customer to resolve the problem. In many cases, it is desirable to establish a real-time response or interaction, either because the customer issue is too complex for a simplistic and textual interaction or due to privacy or business security reasons. Responding quickly to customer posts is desirable from a customer service point of view and limits the possible damage to the company's reputation if negative customer posts remain unanswered.

### SUMMARY

The present invention is generally directed to systems and methods for identifying and responding to a post referencing an entity on a social media page. An entity can be a company, business, organization, institution, individual, etc. The system includes a contact center with a server running an application that receives or identifies posts in public data sources that reference the entity. Once such a post is identified, it is evaluated to see if it came from an identifiable human being rather than a group of people, a company, an institution, an anonymous user, or other non-identifiable source. If the source of the post is from an identifiable person, the application determines whether an action tag is included indicating that the source of the post desires to interact with the business. The action tag is typically placed in the post by the source of the post and is taken from a set of action tags that are either defined by the application or known to the application. An action tag, together with its possible parameters, determines a specific response from the application to the post and the post source. The main embodiment may focus is on real-time communication tags and responses, however, other actionable tags and responses are equally conceivable. Examples include:
@reply: the poster is explicitly asking for a response post from the business. The application does not need to apply (imprecise) natural language processing to the post to determine whether the source would like to receive a response.
@urgent: the post contains a time-sensitive matter, and the source is emphasizing the importance of the business's timely review of the post. For example, the post may describe a security flaw that the source observed in the entity's Web storefront and alerts the business to it but does not necessarily expect a response from the business.
@praise/@rant: the post contains praise for the business/a complaint against the business. Although the source does not ask for a visible response/action from the business, the source wants the business to review and reflect on the post. This action tag adds to the semantics of the post and facilitates the automatic processing of the post through the application in a language-independent manner.

If an action tag is identified, the system retrieves user information from the page and contextual information from the post. At least a portion of the content of the post and/or of the contextual information is used to fashion a response comprising an invitation to communicate. The response can be in the form of a pop-up window. The source can then provide contact information that can be used to establish a communication channel between the source and a representative of the entity. For example, a call, email, text, chat, or other form of communication can be entered into to facilitate problem resolution.

The system can include a contact center or communication server, one or more agent workstations, and one or more user communication devices. The system also includes one or more social media resources. The system can also include one or more enterprise databases. The various components of the system can be interconnected by one or more networks.

The contact center server executes a context aware social callback application. The application scans for or receives indications of posts that reference an entity, either directly or through an associated entity, service, or product of interest. The application determines whether such a post includes or is associated with user information identifying a person who made the post. If an identifiable person is associated with the post, the application determines whether an action tag indicating a desire on the part of the person to communicate with the entity regarding the post is present. Action tags associated with posts might include @call or @chat or other forms of tags that are known to the person and the application. The context of the post, including the action tag and the user information, allows the software to fashion an automatic response.

The action tag allows the person to add predefined and language-independent semantics to the post. The action tag format allows the application to precisely and quickly identify a post as actionable, without having to do natural language processing or inferring user intent from the post context. The specific action to be taken by the application depends on the tag(s) that the user inserts into the post. A simple example might be @call, instructing the application to set up a call between the user and the entity at an unspecified time. A more complex example might be @calllfAvailable (9-17, weekend day) meaning, “establish a call between 9:00 and 17:00 hours on a weekend day in the time zone of the source and when the user is available.” The automatic response may request contact information from the user, which the user may choose to populate. A communication channel can then be established between a user device associated with the posting person and a workstation associated with an agent of the entity. Through the communication channel, the agent can address issues raised by the posting person.

### BRIEF DESCRIPTION OF THE DRAWINGS

FIG. 1 is a block diagram of a system in accordance with embodiments of the present disclosure;

FIG. 2 is a block diagram of a communication server in accordance with embodiments of the present disclosure; and

FIG. 3 is a flow diagram of a process for identifying and responding to social media posts in accordance with embodiments of the present disclosure.

### DETAILED DESCRIPTION

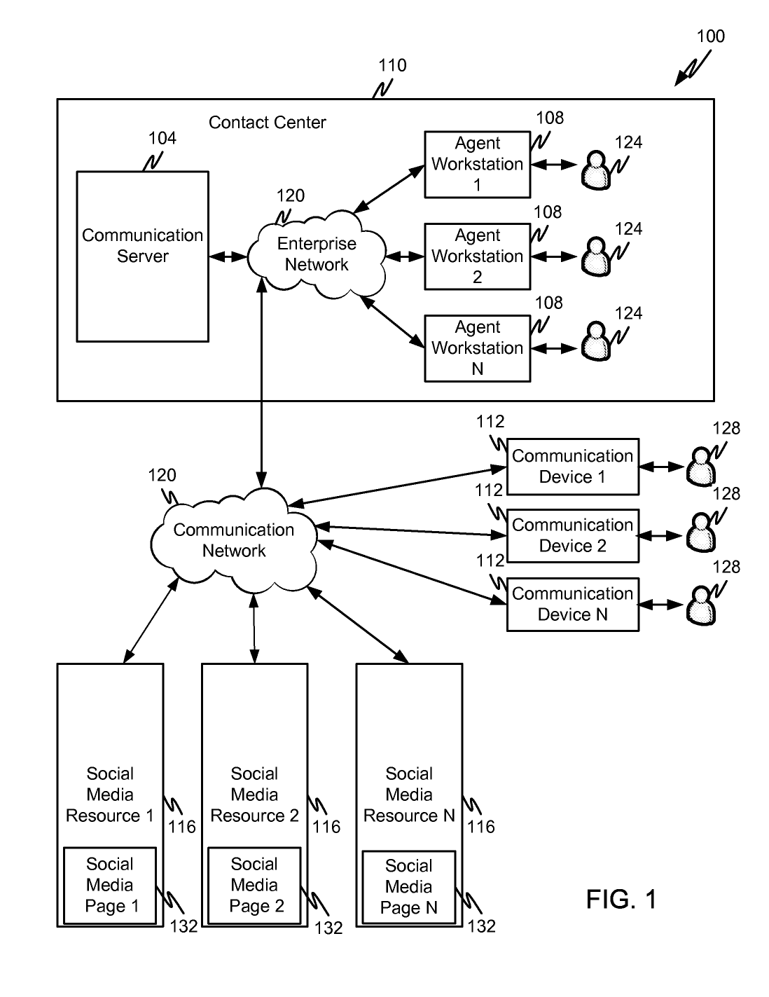

A communication system 100, capable of identifying social media posts referencing an entity and of interacting with persons making such posts is shown in FIG. 1. A social media page can be an Internet site or a distributed network resource. The phrase “distributed network resource” as used herein refers to any resource that is an asset that produces benefit that may be located on more than one computer and connected via a network.

The communication system 100 generally includes a contact center or communication server 104, one or more agent workstations 108, and one or more user communication devices 112. In addition, the system includes one or more social media resources 116. The various components or nodes of the system 100 may be in communication with one another through one or more networks 120. Each agent workstation 108 may comprise a contact center resource and/or may be associated with an agent 124. In addition, each user communication device 112 is associated with a customer or user 128. A social media resource 116 generally supports one or more social media network interfaces or pages 132.

The communication server 104 generally operates to support communications between agent workstations 108 and user communication devices 112. Such communications can be initiated by an agent workstation 108 or by a user communication device 112. Accordingly, the communication server and agent workstations 108 may comprise a contact center 110. The phrase “contact center” as used herein refers to a facility used by companies to manage client contacts made through a variety of mediums such as telephone, fax, letter, e-mail, and online chat. The majority of large organizations use contact centers as a means of managing their client and customer interactions. Further, the contact center can be a system that can communicate with one or more persons that use social media pages 132. The contact center 110 can be hardware, software, or a combination of hardware and software.

In embodiments, the contact center 110 may include all systems whether hardware or software that allow an entity to respond to directed contacts. For example, the contact center 110 can include one or more of, but is not limited to, call or email systems, interfaces to human agents, systems to allow agents to respond to received contacts, one or more systems operable to analyze and improve the function of agent interaction, and/or databases. The contact center 110 can further operate as an automatic call distribution system and/or as a predictive dialing system. In addition, the communication server 104 operates to identify or to receive an indication of posts in social media sites or pages established in connection with social medial resources 116 that reference an entity, a product or offering of the entity, or that is otherwise of interest to the entity, and to initiate communications with a person making the posts, as described in detail herein.

The agent workstations 108 may comprise personal computers, thin clients, telephones, video phones, or the like, alone or in combination. In general the agent workstations 108 may operate to support communications between a human agent 124 and a user 128 of a user communication device 112. An agent workstation may also comprise an automated resource, such as an interactive voice response system or automated attendant.

The user communication devices 112 may comprise personal computers, telephones, smart phones, or the like. Moreover, a single user 128 may be associated with one or more user communication devices 112. For example, a user 128 may utilize communication device 112 comprising a personal computer running a web browser for reading, posting comments, or otherwise interacting with a social media resource 116, and may utilize a communication device 112 comprising a telephone for interactive with a human agent 124. A user communication device 112 can also support different communication channels. For example, a user communication device can support interactions with a social media resource 116 through a web browser, and email communications with an agent workstation 108.

A social media resource 116 can include a web server operable to provide one or more social media pages 132. A social media page can, for example but without limitation, include company pages owned and controlled by an entity, pages about an entity, product, or service offering, specialized interest pages, personal pages, etc. As used herein, the term “social networking site” or “social media page” includes web-based technologies used to turn communication into interactive dialogue between organizations, communities, and individuals. Common forms of social media pages include, for example, collaborative projects (e.g., Wikipedia®), blogs and micro blogs (e.g., Twitter®), content communities (e.g., YouTube®), social media networking sites (e.g., Facebook®), virtual game worlds (e.g., World of Warcraft®), and virtual social worlds (e.g. Second Life®). In general, a user 128 interacts with a social medial page by directing a user communication device 112 to a web site comprising or associated with the social media page 132. The user can then access posts by others, add posts to existing pages, or create new posts on new pages. In addition, an agent workstation 108, communication server 104, or other node associated with an entity can access at least some social media pages 132, such as pages established by the entity and pages that are accessible by the public generally.

The network 120 may be any type of network familiar to those skilled in the art that can support data communications using any of a variety of commercially-available protocols, including without limitation SIP, TCP/IP, SNA, IPX, AppleTalk, and the like. Merely by way of example, the network 120 may be a local area network (“LAN”), such as an Ethernet network, a Token-Ring network and/or the like; a wide-area network (“WAN”); a virtual network, including without limitation a virtual private network (“VPN”); the Internet; an intranet; an extranet; a public switched telephone network (“PSTN”); an infra-red network; a wireless network (e.g., a network operating under any of the IEEE 602.11 suite of protocols, the Bluetooth™ protocol known in the art, and/or any other wireless protocol). The network 120 can be any network or system operable to allow communication within the contact center 110 or between the contact center 108 and the one or more social media resources 116. The network 120 can represent any communication system whether wired or wireless using any protocol or format.

In embodiments, the network 120 provides communication capability for the contact center 110 and/or agent workstations 108 to communicate with the one or more communication devices 112 and social media resources 116. The network 120 can represent two or more networks, where each network is a different communication system using different communication formats or different hardware and software. Each network may contain one or more servers, gateways, routers, switches or other devices that include computer-executable instructions executed by a computer system and encoded or stored on a computer readable medium.

The term “computer-readable medium” as used herein refers to any tangible and non-transient storage that participates in providing instructions to a processor for execution. Such a medium may take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk including without limitation a Bernoulli cartridge, ZIP drive, and JAZ drive, a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present embodiments are stored. Computer-readable storage medium excludes transient storage media, particularly electrical, magnetic, electromagnetic, optical, and magneto-optical signals.

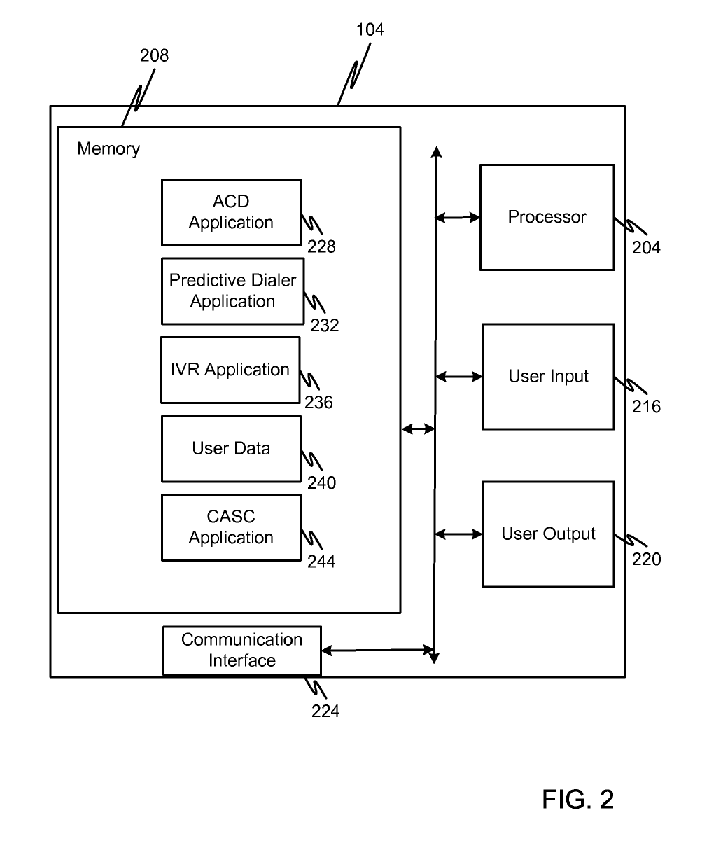

An embodiment of a communication server 104 running an application for context aware social callback in accordance with embodiments of the present disclosure is shown in FIG. 2. The communication server 104 can be running any operating system on any commercially-available server hardware. The communication server 104 can also run a variety of server applications, including SIP servers, HTTP servers, FTP servers, CGI servers, database servers, Java servers, and the like. The communication server 104 may include a processor 204, memory 208, user input 216, user output 220, and a communication interface 224.

The processor 204 can include any general purpose processor or controller for executing application programming. Alternatively, the processor 204 may comprise a specially configured application specific integrated circuit. The processor 204 generally operates to run programming code implementing various functions performed by the communication server 104, including automatic call distribution functions, predictive dialer functions, and functions associated with the operation of the application for context aware social callback as described herein.

The memory 208 can be used in connection with the execution of programming by the processor 204, and for the temporary or long term storage of applications and data. For example, the memory 208 can include an automatic call distribution application 228, a predictive dialer application 232, an interactive voice response system application 236, and/or user data 240. In addition, embodiments of the present invention include a context aware social callback application 244, which may be stored in the memory 208.

The communication server 104 is able to communicate with other elements via the communication interface 224. The communication interface may be a Programmable Communication Interface (“PCI”), Network Interface Controller (“NIC”), Serial Advanced Technology Attachment (“SATA”), a Firewire (IEEE 1394), a Universal Serial Bus (“USB”), or any other type of communication interface. The memory 208 may be one or more disk drives, optical storage devices, solid-state storage devices such as a random access memory (“RAM”) and/or a read-only memory (“ROM”), which can be programmable, flash-updateable and/or the like.

The phrase “application” as used herein refers to computer software or hardware designed to help the user to perform specific tasks. Applications may be part of computer system software or hardware or may be separate software or hardware that can be added. An application can manipulate text, numbers, graphics, or a combination of these elements.

The phrase “the communication” as used herein refers to any post or discrete entry on a social media network page. The communication can include, for example, text, images, links, photographs, graphics, or any representation that may be allowed by a site.

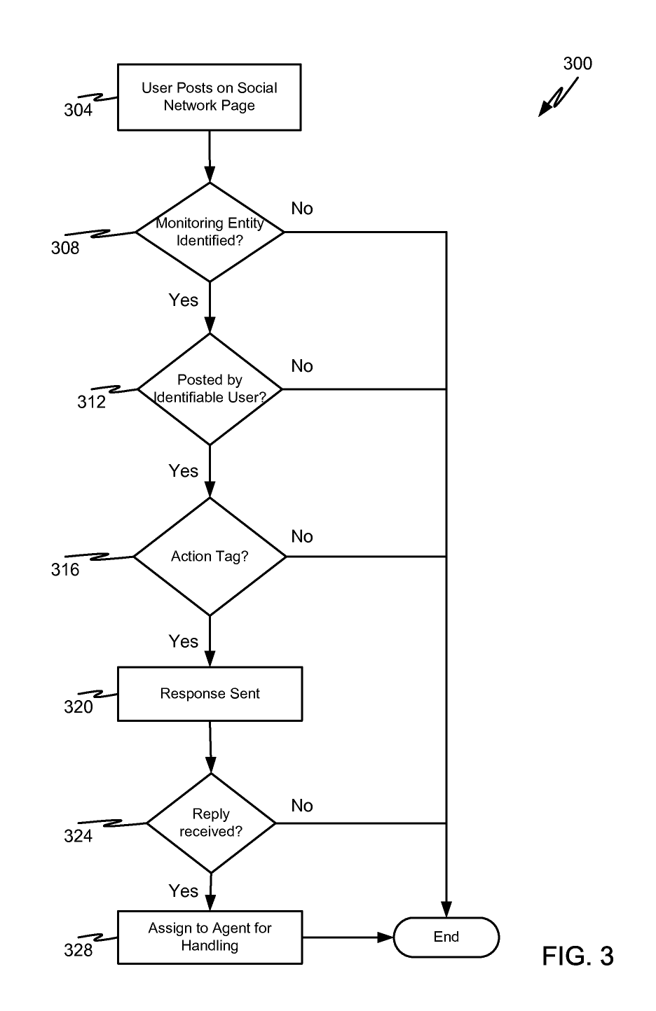

FIG. 3 illustrates aspects of a method in accordance with embodiments of the present disclosure. Initially, at step 304, a user places a post with an action tag on a social media page 132 provided by a social media resource 116. A determination can then be made as to whether the post references or otherwise identifies a monitoring entity (step 308). More particularly, the context aware social callback application 244 or an associated module running on the communication server 104 or an associated node or device can identify the entity in the post. Identifying the entity in the post can include scanning or analyzing posts on social media pages 132 that are accessible to the communication server 104. Alternatively or in addition, identifying the entity in the post can include recognizing the creation of the post on a social media page 132 administered or sponsored by the monitoring entity. Moreover, determining whether the monitoring entity is identified is not limited to determining whether the name of the monitoring entity itself is included in the post. For example, the determination can include determining whether the name of a product, service offering, or other good or service associated with the entity is mentioned. Determining whether the monitoring entity is identified may also include determining whether the entity is mentioned by a nickname, or by a pronoun. For example, where the social media resource 116 is administered by the entity, or where the social media network page 132 is specifically directed to the entity or to an offering of the entity, the reference to the entity may not be by name.

If it is determined that the post with the action tag identifies the entity, a determination can next be made as to whether the post was made by an identifiable user 128 (step 312). A user 128 is an identifiable user 128 when the user 128 making the post with the action tag can be uniquely identified. The unique identification of the user 128 can include a user name, real name, or other unique identifier that is associated with the post with the action tag. If the user is determined to be an identifiable user 128, a determination can next be made as to whether the user 128 has invited a contact or otherwise desires interaction with the entity (step 316). As an example, the user 128 can indicate a desire to interact with or concerning the entity if the post includes an action tag that invites contact. The phrase “tag,” “action tag,” or “tagging” as used herein refers to a non-hierarchical keyword or term assigned to a piece of information (such as a post, Internet bookmark, digital image, or computer file). This kind of metadata helps describe an item and allows it to be found again by browsing or searching. Tagging has been popularized by websites associated with Web 2.0 and is an important feature of many Web 2.0 services. It is now also part of some desktop software.

If the communication is determined by the context aware social callback application 216 to have been posted by an identifiable user 128, and to have an action tag or other indication that the user has invited interaction, a response to the social media post is sent to the user 128 (step 320). The response to the action tag in the post can be a pop up window presented on the user communication device 108 or through the social media resource 116. As another example, the response can be a message sent through an alternate communication channel, such as an email, text, or instant message. In general, the response can invite further communications with the user 128. In addition, the response can include information identifying the user 128 or information derived from identifying information, for example, to address or direct the response. The response can also include text or other information taken from the post, or a message derived from the post or the context of the post. In general, the look, feel, content, and functionality of the response can be fashioned according to the context of the post. The response can also request that the user 128 enter preferred contact information, which can be used by the contact center 106 to enable further communications.

At step 324, a determination can be made as to whether the user 128 has replied to the response message from the communication server 104. If the user 128 has replied, a contact comprising or associated with the additional communications can be delivered to the workstation 108 of an assigned agent or resource 124 for handling (step 328). For example, a contact comprising a call can be initiated by the contact center 104 to the user 128, to place the user 128 in communication with the assigned agent 124. The agent 124 can then engage in communications with the user 128 to address issues raised by the user 128 concerning the entity. The process can then end.

In embodiments, a communication server 104 executing the context aware social callback application 244 is operable to crawl social media network pages to detect relevant communications that reference a monitoring entity and that have action tags. The term “crawl” as used herein refers to any known or created computer application that is able to automatically browse World Wide Web sites. Based on policies, the application is able to search for action tags from one or more World Wide Web sites. If an entity-relevant action tag is identified in step 308, an event is generated to notify the contact center communication server 112 of the post. The contact center communication server 112, in embodiments, may evaluate the post from a social media page 132 to determine whether or not the post was presented by an identifiable human being. If the post was not generated by a person, the post may be discarded, in step 348, and the process ends.

A post on a social medial resource 116 can be parsed in order to identify various included information. For example, metadata associated with a post can be parsed to identify the posting user 128 including but not limited to properties, attributes, and characteristics of the user. In addition, the content of the post can be parsed to determine contextual information which may include but is not limited to key words, phrases, images, and other content. The parsing of a post can be performed by the context aware social callback application 244 or by an associated application or module executed by the communication server 104 or an associated device. The parsed contact and contextual information may be used to generate a response in the form of call or other contact, such as a pop-up window, that is sent to the user 128 who is the source of the post to request communications with the user 128 regarding the post. The response can include a request for the user's preferred mode or address for continued communications. Such continued communications can then use the mode indicated by the user 128.

As described herein, embodiments of the present disclosure allow an entity to monitor for and timely respond to issues regarding the product or service offerings of the entity, or the entity generally. More particularly, information posted on social media network sites is monitored. If posts that are concerned with a monitoring entity are identified, further communications can be initiated. Accordingly, the monitoring entity is provided with an opportunity to participate in dialogue about the entity.

Embodiments of the present disclosure can be implemented by one or more communication servers 104. Moreover, a communication server 104 executing a context aware social callback application 244 as described herein can be operated by an entity for its own purposes and/or the purposes of other entities. In accordance with still other variants, a communication server 104 can be operated as a service provided to one or more monitoring entities.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A communication system, comprising:
a resource communication endpoint;
a communication server;
a context aware social callback application, wherein the context aware social callback application operates to at least one of receive or identify a post with an action tag identifying a first entity, determine that a source of the post identifying the first entity is a human, generate a response to the post, and route the response to the resource communication endpoint.

2. The system of claim 1, wherein the communication server includes a processor and memory, wherein the context aware social callback application is executed by the processor and is stored in memory.

3. The system of claim 2, further comprising:
a contact center, wherein the resource communication endpoint and the communication server are included in the contact center.

4. The system of claim 3, wherein the application is further operable to obtain context about the source of the post from the social network.

5. The system of claim 4, wherein the context information for the source includes information related to an identity of the source.

6. The system of claim 5, wherein the notification that the entity is identified in the social media post is provided to the application by the social network.

7. A communication method, comprising:
receiving at a first system node a notification that an entity has been identified in a social media post;
determining by the first system node that the source of the social media post is an identifiable person;
generating a response to the social media post, wherein the response to the social media post requests contact information from the source.

8. The method of claim 7, further comprising:
receiving a response to the request for contact information from the source;
contacting by the communication resource the source of the social media post using the contact information for the source of the social media post.

9. The method of claim 8, further comprising:
delivering at least some content from the social media post and from the response for contact information for the source to a communication resource.

10. The method of claim 9, wherein soliciting the contact information from the source of the social media post includes generating a window that is presented to the source of the social media post requesting that the source of the social media post provide contact information.

11. The method of claim 10, wherein the window is a pop-up window, and wherein the pop-up window is presented to the source of the social media post by the application engine module to a social media page.

12. The method of claim 7, further comprising:
determining that the social media post includes an action tag indicating that the source of the post desires to interact with respect to the entity.

13. The method of claim 7, further comprising:
receiving at the first system node an indication from a social media network site that the social media post identifies the entity.

14. A non-transitory computer readable medium having stored thereon computer-executable instructions, the computer executable instructions causing a processor to execute a method for identifying and responding to a social media post by a contact center server, the computer executable instructions comprising:
in response to a notification that an entity has been identified in a social media post, determining by the first system node whether the source of the social media post is an identifiable person;
in response to determining that the source is an identifiable person, determining whether the social media post contains an action tag inviting an interaction;
in response to determining that the social media post invites an interaction, generating a response to the social media post, wherein the response to the social media post requests contact information from the identifiable person;
in response to receiving contact information from the source, delivering content from the social media post to a communication resource.

15. The computer readable medium of claim 14, further comprising:
placing the communication resource in communication with the source.

16. The computer readable medium of claim 15, wherein the communication resource includes a human agent.

17. The computer readable medium of claim 16, wherein the contact information for the source is at least one of a telephone number, an email address, an instant message address, or a short message system address.

18. The computer readable medium of claim 17, wherein placing the communication resource in communication with the source includes contacting by the communication resource the source of the social media post using the contact information for the source of the social media post.

19. The computer readable medium of claim 18, wherein the action tag includes an invitation to interact regarding the post.

20. The computer readable medium of claim 19, wherein placing the communication resource in communication with the source includes at least one of a telephone call, an email, an instant message, or a short message.
